(19) United States
(12) Patent Application Publication
(10) Pub. No.: US 2011/0048111 A1
(43) Pub. Date: Mar. 3, 2011

(54) METHOD OF LEAK TESTING AEROSPACE COMPONENTS

(75) Inventor: John H. Vontell, Manchester, CT (US)

(73) Assignee: UNITED TECHNOLOGIES CORPORATION, Hartford, CT (US)

(21) Appl. No.: 12/550,815

(22) Filed: Aug. 31, 2009

(51) Int. Cl. G01M 3/04

(52) U.S. Cl. 73/40.7

(57) ABSTRACT

A method includes providing an aerospace electrical component having a wall and a feature that extends through the wall, introducing a detectable residue-free gas on a first side of the wall, and testing for the presence of the detectable gas on a second side of the wall.

### STATEMENT OF GOVERNMENT INTEREST

This invention was in part produced through funding under a U.S. Government sponsored program (Contract No. N00019-02-C-3003) and the United States Government has certain rights therein.

### BACKGROUND

The present invention relates generally to a method of leak testing components that have internal cavities and more particularly to a method of leak testing aerospace components that have internal cavities.

Aerospace electrical components are particularly difficult to leak test because in many instances they must be leak free prior to and after a molding process which bonds them to additional aerospace components. The electrical components must be leak free prior to the molding process to insure internal dimensional stability. This internal dimensional stability is important for maintaining good electrical contact between male and female electrical components when these components are interconnected. Additionally, aerospace electrical components should be leak free before and after the molding process to ensure that corrosive elements do not enter the interior of the electrical component and corrode the electrical contacts disposed therein. Conventional methods of leak testing, such as water submersion testing, may be difficult or impossible to perform after the electrical components have been bonded to additional aerospace components, or risk introducing corrosive elements into the interior of the electrical components.

Conventional leak testing methods carried out prior to the molding process also risk introducing contaminants to the external surfaces of the electrical components. These contaminants may negatively affect the strength of the bond formed between the electrical components and the additional aerospace components. Further complicating matters, aerospace electrical components typically have thin exterior walls to reduce component weight. The thin component walls can structurally fail if a large pressure differential is created between the internal pressure on the electrical component and the pressure external to the electrical component.

Because introducing contaminants or corrosive elements either internally or externally to the aerospace electrical components can impair component functionality, conventional leak testing can be rather destructive. If a leak occurs or contaminants are determined to have been introduced to the electrical component, the component is generally destroyed, increasing the component scrap rate. This increased scrap rate increases overall manufacturing costs.

### SUMMARY

A method includes providing an aerospace electrical component having a wall and a feature that extends through the wall, introducing a detectable residue-free gas on a first side of the wall, and testing for the presence of the detectable gas on a second side of the wall.

### BRIEF DESCRIPTION OF THE DRAWINGS

FIG. 1 is a sectional view of a gas turbine engine.

FIG. 2 is a perspective view of a section of an inlet case and an inlet strut of a gas turbine engine with an inlet shroud fairing exploded away to show portions of a heater system.

FIG. 3A is a perspective view of an electrical connector.

FIG. 3B is a sectional view of the electrical connector and the outer shell of the shroud fairing viewed along fluid communication element 3B-3B of FIG. 2.

FIGS. 4A-4C show alternative methods of leak testing the electrical connector.

### DETAILED DESCRIPTION

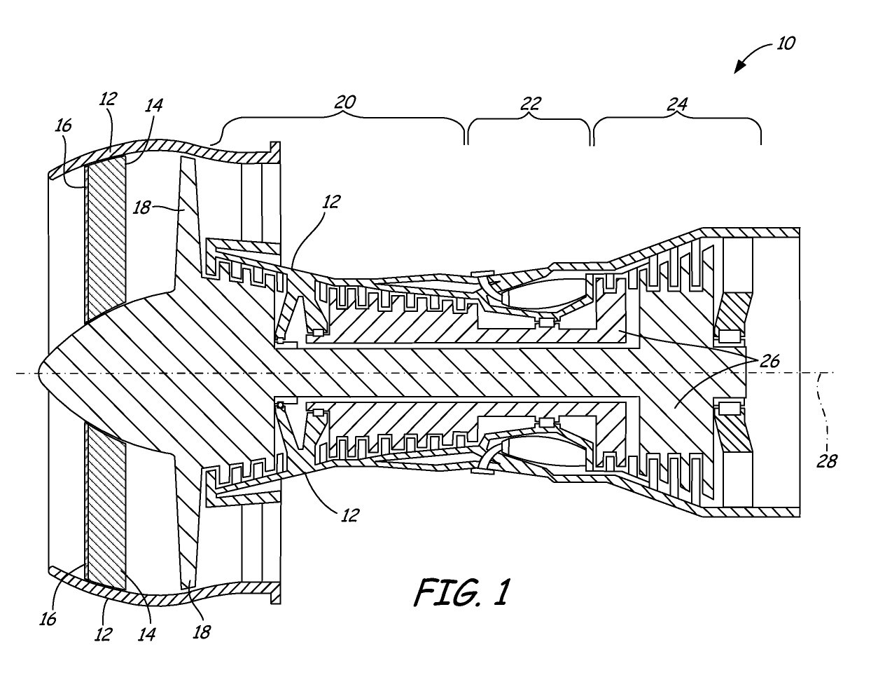

FIG. 1 shows an embodiment of a gas turbine engine 10. The engine 10 includes a casing 12, inlet struts 14, shroud fairings 16, a fan 18, a compressor section 20, a combustion section 22, a turbine section 24, and rotors 26.

In FIG. 1, the casing 12 surrounds the moving components of the engine 10 and defines an airflow passageway. Toward the inlet end of the engine 10, the inlet struts 14 interconnect with the casing 12. At least the leading edge of the inlet struts 14 are surrounded by and secured to the shroud fairings 16. The fan 18 is disposed downstream of the inlet struts 14 and shroud fairings 16. The casing 12 surrounds the compressor section 20, the combustion section 22, and the turbine section 24, which are located downstream of the fan 18. The rotors 26 extend within the casing 12 and interconnect with the fan 14. The turbine section 24 turns the rotors 26. The rotors 26 rotate about a rotational axis 28 to drive the fan 18 and compressor section 20.

The inlet struts 14 may be oriented within the casing 12 to direct intake air into the forward part of the compressor section 20. The shroud fairings 16 (which are wrapped around each of the inlet struts 14) may be heated to prevent the formation of ice on the surfaces of the shroud fairings 16. The air passes between the struts 14 and fairings 16 and is compressed in the compressor section 20. The compressed air is mixed with fuel and burned in the combustion section 22. In the turbine section 24, the gases from the combustion section 22 expand to rotate the rotors 26, which in turn drive the fan 18 and compressor section 20.

FIG. 1 merely illustrates one exemplary embodiment of a gas turbine engine that utilizes electrical components. Aerospace systems other than the propulsion system also utilize electrical components, and therefore, would benefit from the present invention.

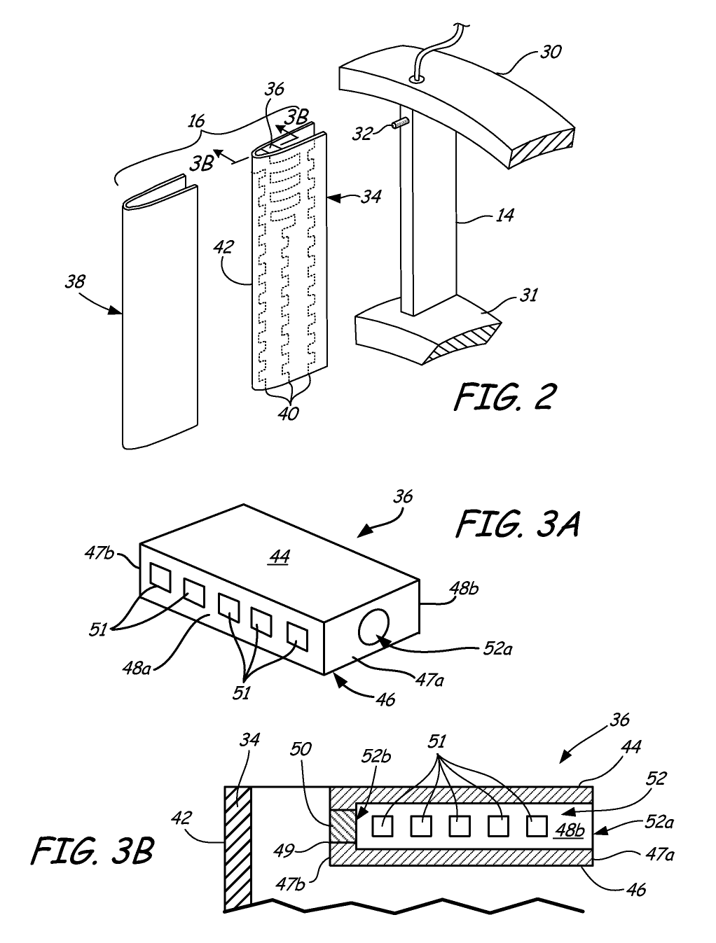

FIG. 2 is a perspective view of a portion of an outer case 30 and an inner case 31 interconnected by one inlet strut 14. FIG. 2 also includes an exploded perspective view of one shroud fairing 16. The inlet strut 14 includes an electrical probe (or plug) 32. The shroud fairing 16 includes a heater mat 34, an electrical connector (or jack) 36, and an outer shell 38. The heater mat 36 includes heating elements 40 and has a leading edge 42.

The inlet strut 14 extends radially inward from the annular outer case 30 to the annular inner case 31. The electrical probe 32 projects from the leading edge portion of the inlet strut 14 is complementary to and inserts into the electrical connector 36 when the shroud fairing 16 is assembled on the inlet strut 14. The insertion of the electrical probe 32 in the electrical connector 36 allows an electrical connection to be formed therebetween.

The shroud fairing 16 includes the U-shaped folded heater mat 34, which surrounds and wraps the leading edge portion of the inlet strut 14. The electrical connector 36 is one particular exemplary type of electrical component, selected from the many aerospace electrical components, which can benefit from the method of leak testing described herein. In FIG. 2, the electrical connector 36 is disposed between the folded sides of the heater mat 34, adjacent the leading edge of the heater mat 34. The electrical connector 36 interconnects with the heater mat 34 and is electrically connected to the electrical elements 40 adjacent the outer radial edge of the heater mat 34. In one embodiment, the outer shell 38 is a ply composite matrix and is molded or otherwise formed over the heater mat 34.

The bond that interconnects the electrical connector 36 and the heater mat 34 can be accomplished by resin transfer molding. Alternatively, the electrical connector 36 can be joined to the heater mat 34 by another type of molding such as compression molding. The electrical connector 36 can also be joined to the heater mat 34 by, for example, autoclaving, welding, brazing, soldering, mechanical crimping/stapling or adhesives. The heater mat 34 and electrical connector 36 may be constructed from any suitable polymeric material or composite polymer matrix. The metallic heating elements 40 extend along the radial length of the heating mat 36 (either along the outer surface or internally within the mat 36) and may be sputtered, insert molded, or adhesively bonded to the heating mat 36. In FIG. 2, the heating elements 40 are deposited within the heating mat 36 and are therefore illustrated with dashed lines.

When the shroud fairing 16 is assembled, the leading edge 42 of the heater mat 34 or a leading portion of the outer shell 38 abuts the inlet strut 14. The sides of the heater mat 34 and outer shell 38 extend rearward around a portion of each inlet strut 14 and may be secured thereto by fasteners or adhesive. The electric probe 32 extending from the inlet strut 14 inserts into the electrical connector 36 to supply power to the heating elements 40. The heating elements 40 provide heat along the entire length of the outer shell 38 thereby preventing the formation of ice on the exterior surface of the outer shell 38 and in any space between the heater mat 34 and the inlet strut 14.

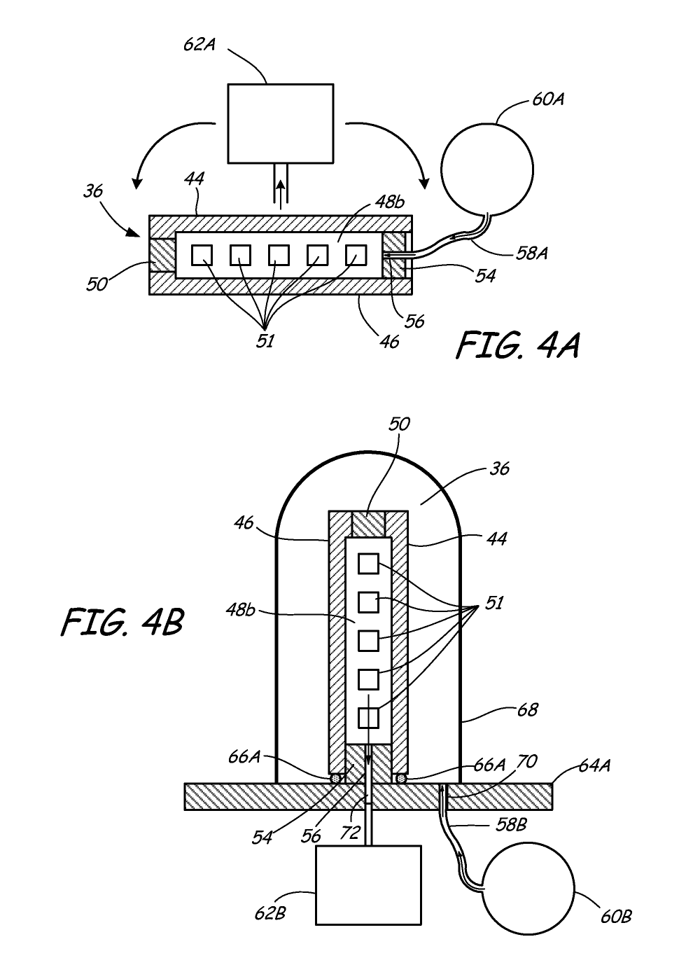

FIG. 3A is a perspective view of the electrical connector 36. FIG. 3B is a sectional view of the heater mat 34 and the electrical connector 36. The electrical connector 36 includes a top wall 44, a bottom wall 46, end walls 47a and 47b, sidewalls 48a and 48b, an aperture 49, a plug 50, and electrical contacts 51. The top wall 44, bottom wall 46, and sidewalls 48 define an interior cavity 52, which has an open end 52a and for receiving the electrical probe 32 and a closed end 52b.

The top and bottom walls 44 and 46 of the electrical connector 36 body extend generally parallel to each other between the folded sides of the heater mat 34. The sidewalls 48a and 48b extend generally perpendicularly between the top and bottom walls 44 and 46. The outer surfaces of portions of the walls 44, 46, 47a, 47b, 48a and 48b may be chemically or adhesively bonded, molded, autoclaved, welded, brazed, soldered, mechanically crimped/stapled/fastened, or otherwise affixed to the heater mat 34. In one embodiment, the plug 50 fills aperture 49 in endwall 47b to form closed end 52b of interior cavity 52. The electrical contacts 51 extend through the sidewalls 48a and 48b from the interior cavity 52 to the exterior of each of the sidewalls 48a and 48b and are electrically connected to the electrical elements 40 of the heater mat 34 (FIG. 2). Together the walls 44, 46, 47a, 47b, 48a, 48b and the plug 50 form the interior cavity 52, which receives the electrical probe 32 when the shroud fairing 16 is assembled on the inlet strut 14 (FIG. 2). More specifically, the electrical probe 32 extends through the open end 52a into the interior cavity 52 when the shroud fairing 16 is assembled on the inlet strut 14.

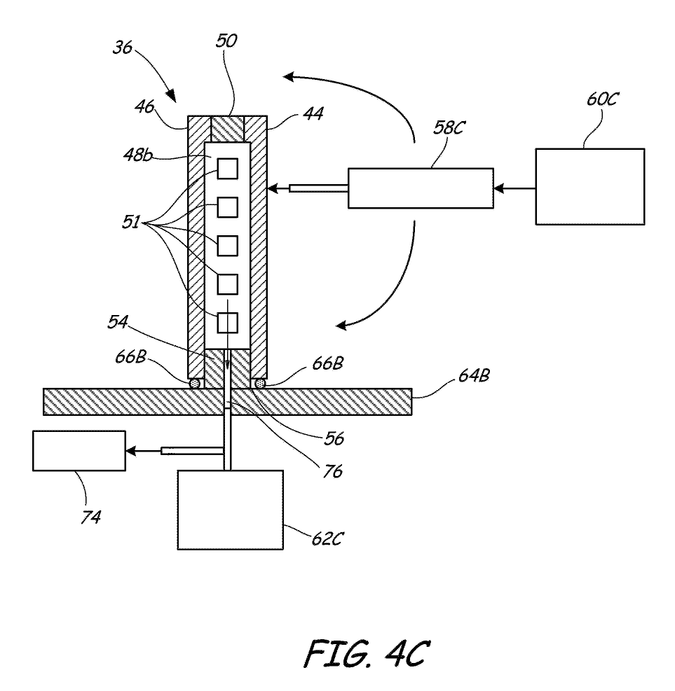

FIGS. 4A to 4C are sectional views of the electrical connector 36 showing alternative methods of leak testing the electrical connector 36. In addition to the components already described, the electrical connector 36 shown in FIGS. 4A-4C includes a second plug 54 which has a port 56 therein.

FIG. 4A illustrates a first method of leak testing the electrical connector 36. The method shown in FIG. 4B includes a fluid communication element 58A, a container 60A, and a detector 62A.

The second plug 54 is temporarily placed in the open end 52a of the electrical connector 36 to hermetically seal the interior cavity 52 during the duration of the leak testing. Once testing is completed the second plug 54 may be removed. The port 56 extends through the second plug 54 to interconnect with the fluid communication element 58A. The fluid communication element 58A may include any means of transferring a gas including tubing or piping.

The fluid communication element 58A transfers the detectable residue-free gas from the container 60A (such as a balloon or tank) through the port 56 to the interior cavity 52. The container 60A acts as a gas source to provide a detectable amount of the residue-free gas to one or several electrical connectors 36. The detector 62A, for example a commercially available helium mass spectrometer (if helium is used as the detectable gas), is moved externally around the walls 44, 46 and 48 and plugs 50 and 54 to check for detectable leaks.

More particularly, the second plug 54 is inserted into open end 52a to hermetically seal the internal cavity 52. Any plug which has a shape capable of mating with open end 52a to hermetically seal the interior cavity 52 may be used. The second plug 54 may be, for example, a silicone, rubber, or foam insert.

By way of example, the second plug 54 may have a flange with a gasket (which abuts the trailing edges of the top and bottom walls 44 and 46 when the second plug 54 is inserted into the open end 52a of the interior cavity 52) and/or may be tapered such that the second plug 54 contacts the walls 44, 46, 47a, 48a and 48b when inserted to a sufficient depth within the internal cavity 52. As the second plug 54 is inserted into open end 52a, the surface of the second plug 54 in contact with the walls 44, 46, 48a and 48b increases while the spacing of the walls 44 and 46 remains generally constant. The tapered second plug 54 creates a hermetic seal when the second plug 54 is inserted a sufficient distance within the internal cavity 52. Alternatively, a range of different expandable plugs such as part numbers 5300+ or 6200+ from Shaw Plugs may be used to create a hermetic seal depending on the testing requirements and geometry of the electrical component.

The fluid communication element 58A transfers the detectable residue-free gas from the container 60A through the port 56 to the interior cavity 52. In one embodiment, container 60A is configured to provide between about 1 psi and about 5 psi (about 6.895 kPa and about 34.47 kPa) of detectable gas to the internal cavity 52 of the electrical connector 36. The only limitation on the pressure provided to the internal cavity 52 is that the pressure differential created should be sufficiently low to maintain the structural integrity of the walls 44, 46, 47a, 47b, 48a, and 48b and plugs 50 and 54. If a leak is present in the electrical connector 36, the detectable gas from the internal cavity 52 will flow from the cavity 52 to the exterior of the electrical connector 36 as a result of the increased pressure of the internal cavity 52 (which results from the addition of the detectable gas) relative to the external pressure on the electrical connector 36. Any gas that escapes from the interior cavity 52 of the electrical connector 36 eventually comes into contact with the detector 62A as it is moved about the electrical connector 36. The detector 62A is capable of indicating the presence of the gas based on this contact to the operator.

A gas is detectable if it is capable of being tested for in a fluid medium such as air. Examples of detectable gases (in addition to helium) may include: carbon dioxide, methane, carbon monoxide, di-nitrogen-monoxide, hydrogen, xenon, argon, neon, and sulfur hexafluoride.

A gas is residue-free if it does not have (solid, liquid, or gas) constituents that negatively interfere with the bond strength between the electrical component and the aerospace component to which the electrical component is bonded. Thus, a gas would not be residue-free if it has constituents which interfere physically to weaken the bonding interface. Similarly, a gas would not be residue-free if it has constituents that interfere chemically with the covalent bonding at the intersection of the component surfaces or inhibit the cure of any polymer(s) the components may utilize. Several examples of solid or liquid constituent residues that inhibit bonding (and are therefore contaminants) include: waxes, oils, salts, oxides or organometallics.

The method of leak testing shown in FIG. 4A allows the electrical connector 36 to be leak tested prior to and after the bonding of the electrical connector 36 to the heater mat 34 (FIGS. 2 and 3B). For example, a balloon may simply be fluidly connected to the electrical connector 36 after the electrical connector 36 has undergone the resin transfer molding process which can be used to bond the connector 36 to the heater mat 34 (FIGS. 2 and 3B). The method of leak testing described also increases the likelihood of that the electrical connector 36 will have internal dimensional stability because a low pressure differential internal and external to the electrical connector 36 can be utilized. The internal dimensional stability of the electrical connector 36 may also be preserved because the leak testing method described can occur prior to the molding process (which has the potential to fill the internal cavity 52 with polymer and resin if a leak is present in the electrical connector 36). Additionally, because a residue-free noncorrosive gas is utilized, the risk that corrosive elements will enter the interior cavity 52 of the electrical connector 36 is reduced. This reduces the likelihood of that the electrical contacts 51 will later corrode. The residue-free gas also reduces the likelihood that contaminants will be introduced to the external surfaces of the electrical connector 36 during leak testing. Thus, the method of leak testing described herein does not negatively impact the strength or durability of the bond between the electrical connector 36 and the heater mat 34.

FIG. 4B shows another method of leak testing the electrical connector 36. The method shown in FIG. 4B includes a fluid communication element 58B, a container 60B, a detector 62B, a support surface 64A, a seal 66A, and a containing element 68. The support surface 64A has a first port 70 and a second port 72 extending therethrough.

The second plug 54 is temporarily placed in the open end 52a of the electrical connector 36 and the electrical connector 36 is disposed such that the second plug 54 abuts the support surface 64A. The support surface 64A may be a structural aerospace member or a metallic base testing plate. The hermetic seal 66A is disposed around the second plug 54 between the endwall 47a and the support surface 64A. The containing element 68 (such as a bell jar) is placed over the electrical connector 36 and contacts the support surface 64A to define an enclosed space around the electrical connector 36.

The first port 70 extends through the support surface 64A to communicate with the enclosed space within the containing element 68. Another portion of the first port 70 interconnects with the fluid communication element 58B which interconnects with the container 60B.

The second port 72 aligns with the port 56 in the second plug 54 and is in fluid communication therewith. A portion of the detector 62B is disposed immediately adjacent to or in direct communication with the second port 72. The detector 62B, for example a commercially available helium mass spectrometer (if helium is used as the detectable gas), is capable of indicating the presence of the gas based on this contact to the operator.

In one embodiment, the containing element 68 is capable of creating a hermetic seal between the enclosed space and the external environment which allows the enclosed space to be positively or negatively pressurized. The fluid communication element 58B transfers a detectable residue-free gas from the container 60B (which may be, for example, a balloon or a tank disposed external to the containing element 68) through the first port 70 to the enclosed space within the containing element 68. In one embodiment, container 60B is configured to provide between about 1 psi and about 5 psi (about 6.895 kPa and about 34.47 kPa) of detectable gas to the containing element 68 of the electrical connector 36. The only limitation on the pressure provided to the containing element 68 is that the pressure differential which results should be sufficient to maintain the structural integrity of the walls 44, 46, and 48 and hermetic seal 66A. If a leak is present in the electrical connector 36, the detectable gas within the containing element 68 will flow from the enclosed space within the containing element 68 to the interior cavity 52 of the electrical connector 36 as a result of the increased pressure within the containing element 68 (which results from the addition of the detectable gas) relative to the internal pressure on the electrical connector 36. In another embodiment, container 60B is configured to provide a pressure differential of about 1 psi and about 5 psi (about 6.895 kPa and about 34.47 kPa) between the pressure of the containing element 68 and the pressure of the interior cavity 52 of the electrical connector 36 (which maybe evacuated or pressurized to several hundred psi). Any detectable gas that enters the electrical connector 36 eventually contacts the detector 62B, which indicates the presence of the gas to the operator.

The method of leak testing shown in FIG. 4B allows the electrical connector 36 to be rapidly leak tested on a pass/fail basis. The method of leak testing described also reduces failure and scrap rates of the electrical connector 36 due to structural failures (such as wall collapse) because testing may be conducted with a low pressure differential internal and external to the electrical connector 36. Additionally, because a residue-free noncorrosive gas is utilized, the risk that corrosive elements will enter the interior cavity 52 of the electrical connector 36 is reduced. This reduces the likelihood of that the electrical contacts 51 will later corrode. The residue-free gas also reduces the likelihood that contaminants will be introduced to the external surfaces of the electrical connector 36 during leak testing. Thus, the method of leak testing described herein does not negatively impact the strength or durability of the bond between the electrical connector 36 and the heater mat 34.

FIG. 4C shows yet another method of leak testing the electrical connector 36. The method shown in FIG. 4C includes a fluid communication element 58C, a container 60C, a detector 62C, a support surface 64B, a seal 66B, and a positive or negative pressure displacement device 74. The support surface 64B has a port 76 extending therethrough.

Similar to the method shown in FIG. 4B, the second plug 54 is temporarily placed in the open end 52a of cavity 52 of the electrical connector 36, and the electrical connector 36 is disposed such that the second plug 54 abuts the support surface 64A. The support surface 64A may be a structural aerospace member or a metallic base testing plate. The hermetic seal 66B is disposed around the second plug 54 between the top and bottom walls 44 and 46 and the support surface 64B. A portion of the detector 62C is disposed immediately adjacent to or in direct communication with the port 76. The port 76 extends through the support surface 64B and aligns with the port 56 in the second plug 54 and allows for fluid communication between the internal cavity 52 and the detector 62C. The negative pressure displacement device 74 is also disposed in fluid communication with the port 76 upstream of the detector 62C.

The fluid communication element 58C, for example a gas probe, piping or tubing, communicates with the container 60C. As it is moved externally around the walls 44, 46, 47a, 47b, 48a and 48b of the electrical connector 36, fluid communication element 58C supplies detectable quantities of gas externally to the electrical connector 36. In one embodiment, between about 1 psi and about 5 psi (about 6.895 kPa and about 34.47 kPa) of detectable gas is supplied externally to the electrical connector 36.

If a negative pressure displacement device 74, for example a vacuum pump, is utilized, the interior cavity 52 of the electrical connector 36 may be evacuated or its pressure may be reduced to create a pressure differential between the interior of the electrical connector 36 and the pressure external to the connector 36. If a leak is present in the electrical connector 36, the detectable gas introduced externally to the electrical connector 36 from the fluid communication element 58C will flow from the external environment to the interior cavity 52 of the electrical connector 36 as a result of the reduced pressure of the interior cavity 52 within the electrical connector 36 relative to the external pressure. Gas that enters the electrical connector 36 eventually contacts the detector 62C, which indicates the presence of the gas to the operator.

The method of leak testing shown in FIG. 4C reduces failure and scrap rates of the electrical connector 36 due to structural failures (such as wall collapse) because testing may be conducted with low pressure differential internal and external to the connector 36. Additionally, because a residue-free noncorrosive gas is utilized, the risk that corrosive elements will enter the interior cavity 52 of the electrical connector 36 is reduced. This reduces the likelihood of that the electrical contacts 51 will later corrode. The residue-free gas reduces the risk of introducing contaminants to the external surfaces which may interfere with the bonding of the electrical connector 36 to the heater mat 34 (FIGS. 2 and 3B). Thus, the method of leak testing described herein does not negatively impact the strength or durability of the bond between the electrical connector 36 and the heater mat 34.

Although the present invention has been described with reference to preferred embodiments, workers skilled in the art will recognize that changes may be made in form and detail without departing from the spirit and scope of the invention.

1. A method comprising:
providing an aerospace electrical component having a wall and a feature that extends through the wall;
introducing a detectable residue-free gas on a first side of the wall; and
testing for the presence of the detectable gas on a second side of the wall.

2. The method of claim 1, wherein the aerospace electrical component is an electrical connector which provides power to an electro-thermal heater of an inlet shroud fairing in a turbine engine.

3. The method of claim 2, wherein the feature that extends through the wall of the electrical connector is an electrical contact which extends through the wall to electrically contact the electro-thermal heater.

4. The method of claim 1, wherein the detectable gas is helium.

5. The method of claim 1, wherein between about 1 psi and about 5 psi (about 6.895 kPa and about 34.47 kPa) of detectable gas is introduced to one side of the wall.

6. The method of claim 1, wherein the detectable gas is introduced on the first side of the wall from a balloon in fluid communication therewith.

7. The method of claim 1, wherein introducing the detectable residue-free gas creates a pressure differential between an internal cavity on the first side of the wall and a hermetically defined space on the second side of the wall.

8. The method of claim 1, wherein creating a pressure differential comprises pulling a vacuum in either one of an internal cavity on the first side of the wall and a hermetically defined space on the second side of the wall.

9. The method of claim 8, wherein the detectable gas is introduced to the opposite side of the wall from the vacuum.

10. The method of claim 1, wherein the detectable gas is introduced either to an internal cavity on the first side of the wall and a hermetically defined space on the second side of the wall from a balloon in fluid communication therewith.

11. The method of claim 1, wherein a pressure differential is created by introducing the detectable gas externally into a defined space surrounding the electrical component and the testing is conducted with a detector in fluid communication with an internal cavity defined by the wall.

12. A method comprising:
attaching an electrical component having a wall to a turbine engine member;
creating a pressure differential across the wall between an exterior and an interior of the electrical component;
introducing a detectable residue-free gas on a first side of the wall; and
testing for the presence of the residue-free gas on a second side of the wall.

13. The method of claim 12, wherein the electrical component is an electrical connector which provides power to an electro-thermal heater of an inlet shroud fairing in a turbine engine.

14. The method of claim 12, wherein the step of attaching includes bonding the electrical component to the turbine engine member utilizing a resin transfer molding process.

15. The method of claim 12, further comprising bonding the electrical component to a turbine engine member utilizing a resin transfer molding process.

16. The method of claim 12, wherein the gas is helium gas.

17. The method of claim 12, wherein between about 1 psi and about 5 psi (about 6.895 kPa and about 34.47 kPa) of detectable gas is introduced to the first side of the wall.

18. The method of claim 12, wherein the detectable gas is introduced from a balloon in fluid communication therewith.

19. A method comprising:
providing an electrical connector that includes a body with an internal cavity having an open end and a closed end, and an electrical contact extending through a wall of the body with a first end exposed to the internal cavity at an interior surface of the body and a second end exposed at an exterior surface of the body;
introducing a detectable residue-free gas; and
detecting whether the detectable residue-free gas has passed through the body between the interior cavity and an exterior of the body.

20. The method of claim 19, further comprising bonding the electrical component to a turbine engine member utilizing a resin transfer molding process prior to detecting for the presence of the detectable residue-free gas.
